(19) United States
(12) Patent Application Publication
(10) Pub. No.: US 2026/0085168 A1
(43) Pub. Date: Mar. 26, 2026

(54) PLANT FIBRE PRODUCT

(71) Applicant: BEYONDWOOD COÖPERATION U.A., Rijsbergen (NL)

(72) Inventor: Wilhelmus Antonius Cornelis MARTENS, Rijsbergen (NL)

(73) Assignee: BEYONDWOOD COÖPERATION U.A., Rijsbergen (NL)

(21) Appl. No.: 19/111,235

(22) PCT Filed: Sep. 12, 2023
(86) PCT No.: PCT/NL2023/050468

§ 371 Date: Mar. 12, 2025

(30) Foreign Application Priority Data
Sep. 15, 2022 (NL) 2033034

(51) Int. Cl. C08J 11/06; B27N 3/04; B27N 3/08; C08J 3/05; C08K 3/22; C08K 3/32; C08K 3/38

(52) U.S. Cl. CPC C08J 11/06; B27N 3/04; B27N 3/086; C08J 3/05; C08K 3/22; C08K 3/32; C08K 3/38; C08J 2397/02; C08J 2407/02; C08K 2003/222; C08K 2003/323

(57) ABSTRACT

The invention relates in general to working or preserving a plant-fibre material, such as a wood-like material, and processing said material, such as in a plastic state in general, and may likewise be considered to be a technology of managing solid or solid-like waste materials, the waste materials comprising plant-fibre material.

### FIELD OF THE INVENTION

The invention relates in general to working or preserving a plant-fibre material, such as a wood-like material, and processing said material, such as in a plastic state in general, and may likewise be considered to be a technology of managing solid or solid-like waste materials, the waste materials comprising plant-fibre material.

### BACKGROUND OF THE INVENTION

Waste is considered to relate to unwanted or unusable materials. Waste is typically a substance which is discarded after a primary use, or otherwise considered worthless. In a circular economy such waste should be avoided, or at least minimized. An example thereof is waste recovery, in order to use the recovered waste in a further application. As such, waste is used as an input material to create valuable products. The amount of waste left for which no further use is (yet) available is there with reduced. Such re-use has certain beneficial side-effects, such as reducing an amount of otherwise used raw materials, saving land space as less waste is deposited, less pollution now and in the future, such as due to washing out, creating work, etc. Therewith waste recovery may be considered as part of a circular economy. A goal thereof is to minimize use of (scarcely available) natural resources, as well as to optimize use of resources in general.

In modern agriculture, horticulture, greenhouse cultivation, forestry, cultural landscape, and so on, huge amounts of waste are produced, typically non-sellable plant materials, such as fibre-comprising materials. These materials are typically discarded, and often burned as biological fuel. Such contributes to carbon dioxide emission. Also methane may be produced from these materials by bacteria. So a re-use of such materials is wanted.

Some plants may comprise fibre and in particular may be grown for such purposes. Some plants may produce fibres as a side product. Or waste material may be obtained from plants having fibres. So various sources of plant fibres exist. Plants with fibres are characterized by having a large concentration of cellulose, giving them their strength. These fibres may be used in composite materials. Fibre crops are generally harvestable after a single growing season, as distinct from trees, which are typically grown for many years before being harvested. In specific circumstances, fibre crops can provide advantages over wood pulp fibre in terms of technical performance, environmental impact or cost A re-use that is typically considered is that of artificial boards wherein use is made of glues, typically [volatile organic] solvent based glues such as trialdehyde glue (urea-formaldehyde, formaldehyde, phenolic). During production this is already an issue. Further, when the plate is burned, amongst others hydrogen is produced, which is highly toxic and has potential huge hazards.

Incidentally, US4339405 (A) recites a process for making cast vegetable/mineral structural products having flame retardant properties utilize a major volume portion of ligneous plant fragments such as soft and hardwoods, sugarcane, cereal and fibre plant stalks, and a minor volume proportion of a mineral binder deposit comprised of magnesium or calcium oxyphosphates and inert filler particles. Fragments having thicknesses ranging from 0.3 mm to 8 mm including chips, shavings, strips, strands, fibre bundles, slivers, fibres and peeled and sawn veneer sheets, have applied to their surfaces an aqueous solution of ammonium polyphosphate or soluble acid phosphate salt supplying from 0.15 to 0.40 parts of P₂O₅ as phosphate ion per part of fragments by weight, and particulate cement solids comprised of MgO or CaO or Mg(OH)₂ or Ca(OH)₂ or MgCO₃ or CaCO₃ ranging from 0.25 to 1.0 part per part of fragment, and from 0.01 to 0.80 parts of inert filler particles and the mixture is moulded and held under predetermined compaction pressure until the product has rigidified, in about 10 minutes' time. The process, however, provides an adhered mineral cladding layer of a surface area of a ligneous body (see e.g. figures), so a main body with ligneous material, and a thin layer [cladding] of mineral origin. Further ammonia is released during production of the material. EP 0 004 372A1 recites flame-retardant moulded articles comprising mineral-clad ligneous particles, from lightweight and low-cost concreted products utilizing as filler material lignocellulosic fragments, and employing as bonding agent some form of mineral cement, to produce building materials. Typical cements have comprised Portland and other hydraulic cements and pozzolans, and magnesia cements such as Sorel cement. The problems of forming products of adequate strength and with densities less than unity arise because of inferior junction bond strength, that is, the adherence of the mineral mass to the woody filler. An understanding of the composition of wood fragments, and the chemistry of the reactants producing the mineral bond mass, may be gained by considering the following discussion. CN 107 130 894 B recites a fireproof door middle seam provided with flame-retardant straw fire prevention boards. The fireproof door middle seam comprises a door frame, door leaves and hinges, wherein the door leaves are connected with the door frame by the hinges; a face exposed to fire and a face unexposed to fire are respectively formed at the two sides of each door leaf; a middle seam is formed by the contact surfaces of the left door leaf and the right door leaf; the left door leaf and the right door leaf are respectively formed by two parts, wherein the four flame-retardant straw fire prevention boards are arranged in the parts at the sides close to the middle seam, and the other parts connected with the flame-retardant straw fire prevention boards are made from steel section; a seam cover plate is also arranged in the fireproof door middle seam and is formed by cutting the flame-retardant straw fire prevention board. The fireproof door middle seam creatively overcomes the defect that a middle seam of the traditional steel or wooden fireproof door is easily deformed in the event of high temperature of a fire; the flame-retardant straw fire prevention boards are set as the parts, close to the middle seam, of the door leaves and the seam cover plate, so that the effects of fire prevention, flame retardance and smoke suppression are effectively achieved; the fireproof door middle seam guarantees the stability of a framework structure of the fireproof door when the fireproof door is in a fire; the middle seam is non-deformable and fireproof. CN 108 101 418 A recites an environment-friendly building material including, by weight, 14-21 parts of calcium silicate powder, 25-29 parts of ethylene-vinyl acetate copolymer, 25-28 parts of polymerized rosin, 17-25 parts of aluminum silicate powder, 5-11 parts of magnesium oxide, 15-27 parts of bamboo carbon powder, 13-17 parts of nano ZnO, 5-7 parts of nano silver, 13-17 parts of zirconium hydrogen phosphate, 5-7 parts of tannin, 5-9 parts of green silicon carbide, and 70-88 parts of plant fibers. In the invention, plant fibers are matched with the ethylene-vinyl acetate copolymer and the polymerized rosin to press the building material, wherein the plant fibers are effectively utilized to turn the wastes into resources. By adding the bamboo carbon powder which has strong adsorption capability, can purify air and eliminate odors, absorb moisture and prevent mildew, and has anti-bacterial effects and using the nano silver, zirconium hydrogen phosphate and tannin, excellent anti-bacterial effect is achieved.

The present invention relates to an improved method of producing a plant-fibre product and various aspects thereof and such a product, which overcomes one or more of the above disadvantages, without jeopardizing functionality and advantages.

### SUMMARY OF THE INVENTION

The present invention relates in a first aspect to a plant fibre product, in particular a structural product. In summary, the present invention provides a sustainable solution of producing and obtaining plant-fibre based materials.

Thereby the present invention provides a solution to one or more of the above mentioned problems.

Advantages of the present description are detailed throughout the description. References to the figures are not limiting, and are only intended to guide the person skilled in the art through details of the present invention.

The present invention relates in a first aspect to a plant fibre product, in a second aspect to a method of producing said plant fibre product, and in a third aspect to a product obtainable by said method.

The present plant fibre product, in particular a wood fragment product, comprises (a) 10-50 wt. % plant fibre, in particular 20-48 wt. % plant fibre, more in particular 22-45 wt. % plant fibre, such as 30-40 wt. %, wherein the plant fibre comprises 2-32 wt. % lignocellulosic biomass, in particular 5-30 wt. %, wherein the plant fibre comprises 5-40 wt. % water, in particular 10-35 wt. % water, more in particular 20-30 wt. % water, wherein plant fibre wt. %'s are based on the total weight of the plant fibre, wherein the fibres have a cross section of 0.01-8 mm (All samples were measured using the SYMPATEC Image Analysis system (IA) QICPIC in combination with the dry disperser GRADIS/L. The symbols and indices employed in the tabular print-outs and graphical representation, as well as the type and form of the plotted results were in accordance with the ISO 13320-1 standard “Particle size analysis—Laser Diffraction methods—Part 1”. In this standard a normative reference is made to ISO 9276—1:1990, “Representation of results of particle size analysis), in particular 0.3-7 mm, such as 0.5-5 mm, (b) 30-60 wt. % magnesium oxide particles, in particular 35-55 wt. %, more in particular 37-40 wt. % MgO, (c) 7-30 wt. % phosphate selected from polyphosphate and phosphate, in particular 10-28 wt. %, more in particular 14-25 wt. %, with the proviso that at least 6 wt. % polyphosphate is present, in particular wherein 40-95 wt. % polyphosphate is present, wherein phosphate wt. % are based on the polyphosphate/phosphate content, more in particular 55-90 wt. % polyphosphate, wherein all wt. % are based on a total weight of the plant fibre product unless otherwise specified, and typically less than 15 wt. % filler, in particular less than 5 wt. % filler, such as less than 0.6 wt. % filler. When using relatively low amounts of fibre more stone-like material is obtained, whereas when using relatively high amounts of fibre a more wood-like material is obtained. So relatively small, but long fibres are used, in particular fresh fibres, that is fibres obtained from plants that have been cut or provided less than a few days ago, such as less than 24 hours ago. The plant fibres contain a relatively large fraction of lignocellulosic biomass, and water, hence the fresh cut aspect. The term “plant fibre” is intended to include all plant-based fibre-like materials, such as single fibres, composite fibres, multiple fibres, bundles of fibres, and so on. Further, typically intimately mixed, MgO provided in the form of particles, and phosphate, are present. A typical thickness is 1-50 mm, in particular 2-20 mm, whereas length and width may be in a range of 10cm-600 cm, for plates or the like. In principle the present product can be provided in any suitable form, typically using a mould thereto. As water is present in various forms, such as in the plant fibre, and/or as the phosphate is provided in the form of a solution in the present process (e.g. 56 wt. % water), a final product may have an amount of water, typically incorporated in the product, of 5-40 wt. % water, typically 8-20 wt. %, such as 15-18 wt. %.

In a second aspect the present invention relates to a method of producing a plant fibre product according the invention, comprising providing 20-40 wt. % plant fibre, wherein the plant fibre comprises 2-32 wt. % lignocellulosic biomass, wherein the plant fibre comprises 5-40 wt. % water, wherein the fibres have a cross section of 0.2-8 mm (as measured using Laser Diffraction with SYMPATEC Image Analysis system (IA) QICPIC (ISO 13320)),

30-60 wt. % magnesium oxide particles, 7-30 wt. % phosphate selected from polyphosphate and phosphate, with the proviso that at least 6 wt. % polyphosphate is present, mixing the plant fibre, the magnesium oxide, and phosphate, during a mixing time and at a mixing temperature, therewith forming a homogeneous mixture, pressing the homogeneous mixture during a pressing time and pressing temperature under a pressure of 10-10.000 kPa, and drying the product at an elevated temperature of 20-80° C. during a drying time to remove volatile compounds, such as ammonia.

### DETAILED DESCRIPTION OF THE INVENTION

In an exemplary embodiment the present plant fibre product comprises 2-30 wt. % of an aqueous dispersion, in particular 10-25 wt. %, the dispersion comprising polymer microparticles, the polymer being selected from natural and synthetic rubbers, in particular wherein the phosphate wt. % is 7-20 wt. %, such as 10-14 wt. %. Therewith a relatively flexible product is obtained, with a good elasticity. The microparticles typically have a size of 10-300 μm, such as 20-200 μm.

In an exemplary embodiment of the present plant fibre product the polymer is selected from natural rubbers, in particular from latex.

In an exemplary embodiment of the present plant fibre product magnesium oxide particles comprise<1 wt. % Mg(OH)₂, and/or wherein the MgO particles are obtained by heating to a temperature of >973 K, in particular>1050K, during a heating period of >60 minutes [dead-burned MgO or DBM].

In an exemplary embodiment of the present plant fibre product magnesium oxide particles comprise<2 wt. % Si, in particular<0.3 wt. % Si. Typically<5.5 wt. % CaO, and/or <8.5 wt. % Fe₂O₃, and even smaller quantities of Cu₂O, TiO₂, Cr₂O₃, and Co₂O₃ may be present, each individually typically<2 wt. %, such as <1 wt. %.

In an exemplary embodiment of the present plant fibre product magnesium oxide particles comprise>60 wt. % Mg on a metal: metal basis, in particular>85 wt. % Mg, more in particular>90 wt. % Mg, such as >95 wt. % Mg. The exemplary MgO comprise 98.5 wt. %.

In an exemplary embodiment of the present plant fibre product the magnesium oxide particles have a mesh size of <200 Mesh (<0.077 mm Sieve size ISO 565:1990 and ISO 3310-1:2000), preferably of <325 Mesh (<0.044 mm), more in particular with a d₉₀ of 0.03 mm, in particular wherein>80% of the magnesium oxide particles have such a mesh size, such as >90%. Typically also a lower average size may be controlled, such as to larger than 0.005 mm, in particular>0.010 mm.

In an exemplary embodiment of the present plant fibre product the polyphosphate and phosphate comprise a cation selected from ammonia, sodium, potassium, hydrogen, and combinations thereof, in particular ammonia.

In an exemplary embodiment of the present plant fibre product the polyphosphate is selected from pyrophosphate (n=2), triphosphate (N=3), tetraphosphate (n=4), pentaphosphate (n=5), hexaphosphate (n=6), heptaphosphate (n=7) and octaphosphate (n=8), such as NP 10-34 or NP 11-37, or NP 12-40.

In an exemplary embodiment of the present plant fibre product the phosphate is orthophosphate (HᵢPO₄).

In an exemplary embodiment the present plant fibre product comprises 0.2-5 wt. % of a boric acid or salt thereof, preferably of tetra boric acid, such as a monovalent salt thereof, such as a sodium salt.

In an exemplary embodiment the present plant fibre product comprises 0.1-30 wt. % additives, in particular 0.3-5 wt. %, wherein additives are preferably selected from natural colorants and natural pigments, such as natural oxides, from carboxylic acids, such as citric acid, from CaO, and from CaCO₃.

In an exemplary embodiment of the present plant fibre product the plant fibre comprises 1-90 wt. % waste plant material, preferably obtained from wood or vegetables.

In an exemplary embodiment of the present plant fibre product the lignocellulosic biomass comprises lignin, cellulose, hemicellulose, pectin, xylem tracheid, vessel elements, and cells.

In an exemplary embodiment of the present plant fibre product the lignocellulosic biomass comprises 5-100% open cells, in particular 10-95% open cells, and/or wherein the lignocellulosic biomass comprises open cells with a cell volume of 10⁻¹⁵−10⁻¹² m³.

In an exemplary embodiment of the present method the plant fibre comprises 10-100% freshly cut plant fibre selected from wood and vegetables, in particular 90-99% freshly cut plant fibre, more in particular 95-98% freshly cut plant fibre, more in particular wherein freshly cut fibre is selected from plants of the plant families of Fagaceae, such as Quercus, Salicaceae, such as Populus and Salix, Rosaceae, Cucurbitaceae, and Solanaceae, and from roadside grass.

In an exemplary embodiment of the present method the plant fibre is obtained from freshly cut trees or bush with a cross-section of a trunk thereof of 1-40 cm, in particular 8-30 cm, in particular wherein the bark is partly or fully removed therewith obtaining a debarked trunk, more in particular wherein the debarked trunk is processed into fibres with a fibre length of smaller than 90 mm, in particular a fibre length of 10-60 mm, more in particular 13-24 mm, a fibre width of <30 mm, in particular a fibre width of 10-20 mm, and a fibre thickness of <8 mm, in particular a fibre thickness of 1-5 mm, more in particular wherein a fibre length:fibre thickness ratio is maintained at >6, in particular a ratio of >10, more in particular a ratio of >15, such as by using a turbo rotor at a rotational speed of >500 rpm with a turbo rotor of size 50 cm diameter.

In an exemplary embodiment of the present method mixing is performed at a temperature of 0-20° C.

In an exemplary embodiment of the present method after mixing the obtained mixture is subjected to a pressure of between 200-3000 kPa, in particular during a press time of 3-120 minutes.

In an exemplary embodiment of the present method the product is dried during a drying period of 30-120 minutes at a temperature of 50-75° C.

In an exemplary embodiment of the present method after mixing the obtained mixture is subjected to a pressure within 90 seconds, in particular within 30 seconds, such as within 10 seconds.

In an exemplary embodiment of the present method or product, the product comprises at least one characteristic selected from 90-100% recyclable, a thermal extension coefficient of <0.005 mm/(m*° C.), fire safe according to NEN class B or class A2, at least 10 years durable, a density of about 1.5-2 kg/dm³, processable as an alternative to wood, a moisture uptake of <5 wt. % (at 20° C. under 90%RH, during 48 hours), in particular<2 wt. %, more in particular<0.1 wt. %, a modulus of elasticity of >10 kN/mm², a modulus of rupture of >10 N/mm², typically>15 N/mm², and often>20 N/mm², in particular according to NEN-EN 14080/NEN EN 338, and biodegradability. With a RH of 98% at 70° C. a dimensional increase of 0.04% relative is obtained. It is found that with a relative increase of e.g. 10% plant fibre, a density drops with about 0.1 kg/dm³.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### EXPERIMENTS

### Experiments

Basic Process An exemplary basic process relates to steps of mixing, pressing, and drying of raw materials, in particular fresh wood, magnesium oxide. and ammonium polyphosphate. As a result the following specific properties are obtained in a final product: fire safety, hardly any stretching and shrinkage, fully recyclable, no rotting, constructive properties, processable as wood.

### Raw Materials

### Fresh Wood

Use is made of the open structure of wood cells, hence fresh wood is used. A reaction may occur with cellulose, hemicellulose or lignin, being present in the fresh wood fibres. It is found that the open structure of wood takes up the minerals provided in the present method which minerals then react. The open structure is mostly determined by the amount of tracheid's and the size of the tracheid's in the cell wall of the wood. The thickness of the wood is considered important, about 0.2 mm to a maximum of 8 mm thickness is found to be suitable range, as the minerals are found to penetrate into the cells. In order for the reaction to take place in the cell a moisture content of between 15% and 35% is preferred. If there is an overdose of liquid, which may be the case so far, ammonia may be created as a residual product. A higher ratio of fibres in the final product may affect a higher degree of ammonia binding.

The raw wood is processed into fibres in the basic process. For this purpose, wooden logs of at least 8 cm to 30 cm are used. These logs are completely stripped of the bark. These debarked logs are then processed in a Laimet chipper which processes the logs into consistent chips of up to 24 mm long, 10-20 mm wide and 1-5 mm thick. These chips are then processed into fibres by a turbo rotor where the goal is to retain as much length as possible at maximum thickness. Long thin fibres are preferred as they positively influence strength properties.

### Magnesium Oxide

Magnesium oxide is preferably dead-burned (DBM), that is treated at an elevated temperature; for example MgO briquettes pass through a very hot oven (2200° C.) which makes them very compact. Such DBM can be obtained from NedMag B.V. in Veendam. Said DBM has a purity of on average 98.5%. Such dead-burned magnesium oxide provides an improved reactivity; not sufficiently burned magnesium oxide may give rise to a too fast reaction which makes the process technically difficult to mix with the current knowledge.

In addition, the particle size is found important; in particular relatively small particles can be absorbed into the cells of the wood fibres. This also depends on the size of the tracheid openings in the fibres. In addition, it is found that in the ratio of raw materials for the final product, a higher amount of wood fibres in the product requires smaller particles of magnesium oxide. The current specifications of a preferred embodiment is to use magnesium oxide of which 90% has a size of 30 microns or smaller.

The magnesium oxide does not have to be very pure, certainly not food grade. 90% pure is found enough typically. It is important that an amount of other minerals in the magnesium oxide is preferably in the form of oxides (such as calcium oxide and iron oxide), and that as little silica as possible is present in view of carcinogenicity.

(Ammonium poly)phosphate

The phosphate, in particular Ammonium polyphosphate, is preferably a liquid for a proper application in the process. Important is the share of polyphosphates, preferably of at least 55%-60%. With a higher percentage of polyphosphate the material shows better properties (more stable, stronger and higher fire safety). In addition, there may be a relationship of the phosphate with the number of fibres; the more fibres the more polyphosphates are needed to bind. There is an influence found of viscosity in absorption by the fibre.

### Other Raw Materials

These other raw materials may complete the basic process:
Calcium oxide, improvement in strength properties
Calcium carbonate, better binding with NH₄ in the product
Citric acid, [partly] replacing ammonium polyphosphate
Borax, reaction retardant
Other oxides for colouring the material through and through. Such as iron oxides yellow, red, black and mixed making brown, titanium dioxide white. The addition of these oxides affect the reaction and thus the properties of the material.
Latex, increases the malleability of the final product. Material becomes softer in structure and more wood-like. Can be partially used to replace ammonium polyphosphate. The addition of latex improves the ammonia binding in the material.

### Process

### Production Samples

Samples are made in a cooled environment of minimum 5 degrees Celsius to maximum 20 degrees Celsius. Magnesium oxide and ammonium polyphosphate come from a storage at a temperature below 0 degrees Celsius, wood fibre is cooled to around 5 degrees Celsius, typically not colder than 0 degrees Celsius. The raw materials are stored under these lower temperature conditions to slow down the exothermic reaction which occurs upon mixing.

Mix 80 grams of wood fibre with 266 grams of magnesium oxide, this is mixed well until the powder is visually completely mixed with the fibre. Then 133 grams of liquid, typically water, is added via a nebulizer, from then on the mixture is mixed in 1 minute. The mixture is dosed into a steel mould and pressed under a workshop press with a pressure between 2 and 30 bar (200 and 3,000 kPa). The pressed slab is held in the press for ten minutes and then dried at 65 degrees Celsius for one hour. The released moisture and ammonia are disposed of.

Tests with samples: ratio of liquid to powder is reduced and as far as possible an amount of fibres is increased.

### Production Pilot Line—Batch Wise

Samples are made in a cooled environment of minimum 5 degrees Celsius to maximum 20 degrees Celsius. Magnesium oxide and ammonium polyphosphate come from storage with temperature below 0 degrees Celsius, wood fibre is cooled around 5 degrees Celsius, not colder than 0 degrees Celsius. The fibres are supplied on a conveyor belt to the mixer, spread out as much as possible and are preferably minimally hooked together. The powder is supplied to the mixer via a feeder. The fibres and powder are introduced into the mixer at the same location. In the mixer, the liquid is dosed and mixed. 2 seconds later, the mixture falls onto a belt that carries the mixture to the press. Under the press, the mixture is pressed under pressure and then dried.
Pressure is as mentioned above
Ratio of raw materials (when mixing is consistent it is only really possible to investigate ratios in relation to properties) may vary as claimed
Addition of alternative raw materials (see other raw materials) may be as claimed
Drying process (long drying with a lower temperature or quick drying with a higher temperature) may be as claimed
Ambient temperature may be as claimed
   Other factors considered to be less relevant:
Properties of raw materials, as for example:
Different types of wood
   Fibre length/thickness [as long as within the claimed boundaries]
Moisture percentage fibre as claimed
Different particle size powder as claimed
Temperatures and time of burning magnesium oxide, as obtained
Influence of purity of magnesium oxide as described
Influence polyphosphate content as described
Influence APP colour
Temperature of raw materials for mixing (e.g. cooling of powder)
Temperature control of production process (e.g. heated press)

### Continuous Production

Same setup as batch production with own management for processing raw materials.

Difference between full continuous and batch production: continuous supply of raw materials, continuous mixing and continuous press. All previous steps in temperature regime. Drying and capture of ammonia depending on the results achieved.

### Properties Final Product

These properties are tested for validation.

Dimensional stability based on heat and moisture:
At +/−10% moisture absorption by weight limited dimensional increase therefore hardly any expansion due to temperature and humidity.
Hardly any expansion due to temperature increase.
   Strength properties have now been reached:
Modulus of Elasticity [MOE]-12.000/15.000 N/mm²
Modulus of rupture [MOR]-15/20 N/mm².

Higher strength properties can be achieved after an optimal ratio of raw materials.

Fire safety class B, A2 achievable depending on optimization.

End product does not rot anymore, due to modification of the wood fibres.

### Recyclability of the End Product:

Technical recycling: grinding of the product a percentage can be used to replace the magnesium oxide.
Biological recycling: grinding of the product so that it can be absorbed by the soil and released as a fertilizer. In case of Beyond Wood, this fertilizer also includes fibre, which may contribute to the soil structure.
   Processing the end product as building material:
Processable as wood, sawing, screwing, shooting. Depending on the quantity of fibres, it is easier to process (without pre-drilling).
In comparison, when shooting, at corner of a product, wood cracks open, whereas concrete folds open. The present material does not show either of these.
Material is good for gluing.

### Maintenance:

Material suffers less (e.g. degree of brittleness) due to low stretch/shrinkage.
Low elongation/shrinkage also results in less deterioration of coatings.
No infestation by insects and/or rodents.

### Experimental Results

The following tests are performed giving some initial results.
MOR (modulus of rupture): 19.40 N/mm² (hand samples+hand press)-21.54 N/mm² (hand samples+double band press)
MOE [Young's]: 13,723 kN/mm² (hand samples+hand press)-15,368 kN/mm² (hand samples+double band press)
Fire class: B-required value FIGRA≤120 W/s; measured 12,8 W/s required value THR 600 s≤7,5 MJ; measured 1,12 MJ
S1—required value SMOGRA<30 m²/s²; measured 2,59 m²/s² required value TSP 600 s<50 m²; measured 25,9 m²
Freeze—thaw: according to ASTM-C1186-08[2016] for a type A Grade II material
MOR dry measured: 13,55 N/mm²
MOR measured wet: 7.61 N/mm²
MOR after freeze-thaw after 50 cycles of 1 hour: 7.88 N/mm²

Dimensional increase: 0.093%.

Moisture absorption: 23%
Moisture content: 11.58%
No visual delamination
Assessment of adhesive system for bonding of cladding panels
Method:

14 days curing of adhesive at 23° C. and 50% RH

7 days soaking in demineralized water at 23° C.; 2 hours drying at 23° C.

3 days storage at −30° C.; 2 hours drying at 23° C.

3 days storage at 80° C.; 2 hours drying at 23° C.

7 days cataplasma at 70° C. and 95% RH

When carrying out a suited procedure, the material can be glued well
Boiling test.
Mass increase is high (9.6%), yet the dimensional increase remains limited (0.25% on average). It is likely that water will remain between the pores increasing the weight, but not affecting the dimensions.
Climate chamber 70° C./98% RH
After 1 week: mass increase 1.7%, dimensional increase 0.04%, so hardly any expansion as a result of temperature+humidity
Density
By immersion=1.78 kg/dm³ (on small pieces of 2 cm by 2 cm)
By weighing+measuring=1.60 kg/dm³ (on bigger pieces of±20 cm on±20 cm)
Apparently the density is almost constant over the entire profile, with a small non-homogeneous distribution of the components in the cross section.
DMA (dynamic mechanical analysis)
Twinson contains PVC with a Tg of 78.4° C., which causes a clear decrease of the storage modulus
The present plant fibre product (BeyondWood™) contains no thermoplast, consequently no Tg, thus no sharp decrease in stiffness.
It takes up to 98° C. for the modulus of Beyond Wood to drop to the same stiffness as Twinson at room temperature
Linear thermal expansion
Beyond Wood at 0.003 mm/m. ° C., so hardly any expansion as a result of temperature increase
Twinson à 0.021 mm/m. ° C.
PVC à 0.070 mm/m. ° C.
Surface Temperature
With the black standard set at 75° C., the material reaches 59.9° C.
Given the DMA story above, no deformation will occur at this temperature because the stiffness remains sufficiently high.

It should be appreciated that for commercial application it may be preferable to use one or more variations of the present system, which would similar be to the ones disclosed in the present application and are within the spirit of the invention.

Wherefore I/we claim:

1. A plant fibre product comprising
(a) 10-50 wt. % plant fibre,
wherein the plant fibre comprises 2-32 wt. % lignocellulosic biomass,
wherein the plant fibre comprises 5-40 wt. % water wherein plant fibre weight percentages are based on the total weight of the plant fibre,
wherein the plant fibre comprises fibres, the fibres having a cross section of 0.2-8 mm as measured using Laser Diffraction with SYMPATEC Image Analysis system QICPIC according to ISO 13320,
(b) 30-60 wt. % magnesium oxide particles,
(c) 7-30 wt. % phosphate selected from polyphosphate and phosphate, with the proviso that at least 6 wt. % polyphosphate is present, wherein phosphate weight percentages are based on the combined polyphosphate and phosphate content, wherein all weight percentages are based on a total weight of the plant fibre product unless otherwise specified.

2. The plant fibre product according to claim 1, comprising 2-30 wt. % of an aqueous dispersion,
the dispersion comprising polymer microparticles,
the polymer being selected from natural and synthetic rubbers, and wherein the phosphate wt. % is 7-20 wt. %

3. The plant fibre product according to claim 2, wherein the polymer is selected from natural rubbers.

4. The plant fibre product according to claim 1, with at least one of the following
magnesium oxide particles comprise<1 wt. % Mg(OH)₂, the MgO particles are obtained by heating to a temperature of >973 K during a heating period of >60 minutes,
magnesium oxide particles comprise<2 wt. % Si,
magnesium oxide particles comprise>60 wt. % Mg on a metal to metal basis,.

5. The plant fibre product according to claim 1, wherein the magnesium oxide particles have a mesh size of <200 Mesh measured using<0.077 mm Sieve size according to ISO 565:1990 and ISO 3310-1:2000,.

6. The plant fibre product according to claim 1, wherein the polyphosphate and phosphate comprise a cation selected from ammonia, sodium, potassium, hydrogen, and combinations thereof.

7. The plant fibre product according to claim 1, wherein the polyphosphate is selected from pyrophosphate (n=2), triphosphate (n=3), tetraphosphate (n=4), pentaphosphate (n=5), hexaphosphate (n=6), heptaphosphate (n=7) and octaphosphate (n=8), and wherein the phosphate is orthophosphate.

8. The plant fibre product according to claim 1, comprising 0.2-5 wt. % of a boric acid or salt thereof.

9. The plant fibre product according to claim 1, comprising 0.1-30 wt. % additives, wherein additives are selected from natural colorants and natural pigments.

10. The plant fibre product according to of claim 1, wherein the plant fibre comprises 1-90 wt. % waste plant material, obtained from wood or vegetables.

11. The plant fibre product according to claim 1, wherein the lignocellulosic biomass comprises lignin, cellulose, hemicellulose, pectin, xylem tracheid, vessel elements, and cells.

12. The plant fibre product according to claims 1, wherein the lignocellulosic biomass comprises 5-100% open cells, and wherein the lignocellulosic biomass comprises open cells with a cell volume of 10⁻¹⁵−10⁻¹² m³.

13. Method of producing a plant fibre product according to claim 1, comprising providing 10-50 wt. % plant fibre,
wherein the plant fibre comprises 2-32 wt. % lignocellulosic biomass,
wherein the plant fibre comprises 5-40 wt. % water,
wherein fibres have a cross section of 0.2-8 mm as measured using Laser Diffraction with SYMPATEC Image Analysis system QICPIC according to ISO 13320,
30-60 wt. % magnesium oxide particles,
7-30 wt. % phosphate selected from polyphosphate and phosphate,
with the proviso that at least 6 wt. % polyphosphate is present,
mixing the plant fibre, the magnesium oxide, and phosphate, during a mixing time and at a mixing temperature, therewith forming a homogeneous mixture, pressing the homogeneous mixture during a pressing time and pressing temperature under a pressure of 10-10.000 kPa, and
drying the product at an elevated temperature of 20-80° C. during a drying time to remove volatile compounds,

14. The method according to claim 13, wherein the plant fibre comprises 10-100% freshly cut plant fibre selected from wood and vegetables.

15. The method according to claims 13-14, wherein the plant fibre is obtained from freshly cut trees or bush with a cross-section of a trunk thereof of 1-40 cm.

16. The method according to claim 13, wherein mixing is performed at a temperature of 0-20° C.

17. The method according to claim 13, wherein after mixing the obtained mixture is subjected to a pressure of between 200-3000 kPa and wherein the product is dried during a drying period of 30-120 minutes at a temperature of 50-75 ° C.

18. The method according to claim 13, wherein after mixing the obtained mixture is subjected to a pressure within 90 seconds.

19. Product obtained by a method according to claim 13, wherein the product comprises at least one characteristic selected from 90-100% recyclable, a thermal extension coefficient of <0.005 mm/(m*° C.), fire safe according to NEN class B or class A2, at least 10 years durable, a density of 1.5-2 kg/dm³, processable as an alternative to wood, a moisture uptake of <5 wt. %, a modulus of elasticity of >10 kN/mm², a modulus of rupture of >10 N/mm², and biodegradability.

20. The method according to claim 13, wherein the plant fibre comprises 10-100% freshly cut plant fibre selected from wood and vegetables, and wherein freshly cut fibre is selected from plants of the plant families of Fagaceae, Salicaceae, Rosaceae, Cucurbitaceae, and Solanaceae, and from roadside grass.

21. The method according to claim 13, wherein the plant fibre is obtained from freshly cut trees or bush with a cross-section of a trunk thereof of 8-30 cm, wherein the bark is partly or fully removed therewith obtaining a debarked trunk, and wherein the debarked trunk is processed into fibres with a fibre length of smaller than 90 mm, a fibre width of <30 mm, and a fibre thickness of <8 mm.
